(19) United States
(12) Patent Application Publication
(10) Pub. No.: US 2003/0117355 A1
(43) Pub. Date: Jun. 26, 2003

(54) Field sequential liquid crystal display device and driving method therefor

(75) Inventor: Shingo Yamauchi, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/316,439

(22) Filed: Dec. 11, 2002

(30) Foreign Application Priority Data
Dec. 21, 2001 (JP) 2001-390057

(51) Int. Cl. G09G 3/36

(52) U.S. Cl. 345/87

(57) ABSTRACT

A liquid crystal display device incorporates, within the same integrated circuit, a plurality of memories which store R, G, and B data supplied in parallel from an image source for the respective color components, a multiplexer which serially reads out the R, G, and B data stored in these memories and supplies them to the liquid crystal display unit, a mode switch, a D/A converter, and a buffer amplifier.

### CROSS-REFERENCE TO RELATED APPLICATIONS

This application is based upon and claims the benefit of priority from the prior Japanese Patent Application No. 2001-390057, filed Dec. 21, 2001, the entire contents of which are incorporated herein by reference.

### BACKGROUND OF THE INVENTION

1. Field of the Invention

The present invention relates to a field sequential liquid crystal display device and its driving method.

2. Description of the Related Art

A liquid crystal display device for displaying color images has been studied, which includes a liquid crystal display unit, a backlight, and a control means. The liquid crystal display unit has a liquid crystal sandwiched between a pair of substrates with electrodes formed on their opposing inner surfaces and displays an image by controlling transmission of light through the liquid crystal. The backlight is placed behind the liquid crystal display unit and sequentially emits light beams of a plurality of colors to the liquid crystal display unit in predetermined cycles. The control means writes display data corresponding to one of the plurality of colors of the light beams emitted to the liquid crystal display device for each of the plurality of subframes obtained by dividing one frame for displaying one color image by the number of colors of light beams emitted from the backlight, and outputs light beams of colors corresponding to the display data from the backlight. This device displays one color image by synthesizing display of a plurality of colors for each of the plurality of subframes.

This scheme is generally called the field sequential scheme. In this field sequential liquid crystal display device, display data corresponding to one of the above colors is written in the liquid crystal display unit for each of the plurality of subframes, and light beams of colors corresponding to the written display data are emitted from the backlight to the liquid crystal display unit in this state.

In this field sequential liquid crystal display device, the liquid crystal display unit has no color filters, and hence no light is absorbed by color filters. In this device, one color image is displayed by synthesizing bright light beams of a plurality of colors for each of the plurality of subframes obtained by dividing one frame by the number of colors of light beams emitted from the backlight. Therefore, a color image can be displayed, which is brighter and higher in resolution than the image displayed by a liquid crystal display device using a liquid crystal display unit having color filters of a plurality of colors corresponding to each of a plurality of pixels.

FIG. 8 shows a general image data transfer step in the field sequential scheme. As shown in FIG. 8, image data R, G, and B of the primary colors supplied in parallel from an image source 12 are temporarily stored in an image memory 13 formed from, for example, a VRAM, in accordance with a clock having a frequency fs in an image output circuit 11.

The image data R, G, and B stored in the image memory 13 are sequentially read out as serial data in accordance with a clock having a frequency 3 fs and sent to a display driver 15 of a module circuit 14.

The display driver 15 has a latch circuit 15a and buffer amplifier 15b. The image data serially sent from the image output circuit 11 are sequentially latched in the latch circuit 15a, and then supplied to a display device 16 including a liquid crystal display unit through the buffer amplifier 15b, thereby displaying an image corresponding to the image data.

As described above, in the general image data transfer step in the field sequential scheme, the parallel image data R, G, and B are stored in the image memory 13 before they are sent to the module circuit 14, and the image data R, G, and B stored in the image memory 13 are serially read out to be supplied to the module circuit 14.

In addition to the module circuit 14, therefore, many external electronic components such as the image output circuit 11 are required. In addition, the power consumption of the overall system becomes high, and the manufacturing cost increases.

### BRIEF SUMMARY OF THE INVENTION

It is an object of the present invention to provide a liquid crystal display device and its driving method which can simplify an arrangement other than module circuits including the liquid crystal display unit to reduce the overall circuit size, thereby contributing reductions in power consumption and manufacturing cost.

In order to achieve the above object, according to an aspect of the invention, there is provided a liquid crystal display device comprising a matrix liquid crystal display unit having a plurality of pixels arranged in the form of a matrix, an illumination device which is placed behind the display unit and sequentially emits light beams of a plurality of colors to the liquid crystal display unit in predetermined cycles, and a display driver formed into an integrated circuit which supplies display data corresponding to one of the plurality of colors to the liquid crystal display unit for each of a plurality of fields obtained by dividing one frame for displaying one color image by the number of colors of light beams emitted from the illumination device to cause the illumination device to emit light beams of corresponding colors in accordance with display of the display data, thereby displaying one color image upon synthesis of display of a plurality of colors for the respective fields, wherein the display driver has a plurality of memories which store display data of a plurality of colors for the respective color components, a memory write section which causes the plurality of memories to store display data of a plurality of colors supplied in parallel from an image source for the respective color components, and a display data read circuit which serially reads out for each color display data of a plurality of colors stored in the plurality of memories and supplies the display data to the liquid crystal display unit, the memories, the memory write section, and the display data read circuit being formed within the same integrated circuit.

According to an aspect of the invention, parallel color image data from an image source can be directly received by the driver module of the liquid crystal display unit, and the received data can be converted into serial data upon being stored in the storage means (memories) arranged in the module, thereby driving the display device. This makes it possible to greatly simplify the arrangement between the image source and the driver module. In addition, this arrangement can contribute to a reduction in EMI due to the wiring pattern and a reduction in signal loss at the time of image data transfer.

The plurality of memories are preferably formed from a plurality of FIFO (First In First Out) memories, and also preferably formed from memories each having a storage capacity of not less than 2×n×m bits, where n is the number of bits representing one image data by digital data and m is the number of scanning lines of the liquid crystal display unit. In addition, if the illumination device comprises a light source which emits light beams of primary colors of red, green, and blue, the plurality of memories are preferably formed from three memories which respectively store display data of the respective color components of red, green, and blue.

Preferably, the memory write section concurrently and continuously writes display data of a plurality of colors for the respective color components over a plurality of frames in the corresponding memories of the plurality of memories, and the display data read section sequentially reads out display data, of display data corresponding to a plurality of frames stored in the memories corresponding to the respective colors, which correspond to at least a frame immediately preceding a frame for which the display data are written from the memories corresponding to the respective colors. Preferably, when the plurality of memories comprise three FIFO (First In First Out) memories each having a storage capacity of not less than 2×n×m bits, where n is the number of bits representing one image data by digital data and m is the number of scanning lines of the liquid crystal display unit, the memory write section concurrently and continuously writes display data of three colors for the respective color components over the two frames in the respective memories corresponding to the respective color components, and the display data read section sequentially reads out display data, of display data corresponding to two frames stored in the memories corresponding to the respective colors, which correspond to a frame immediately preceding a frame for which the display data are written from the memories corresponding to the respective colors, as display data for the respective fields, in a predetermined order of the memories of the respective colors. With this arrangement, the structure of the display driver can be simplified.

Preferably, the display driver further has a monochrome data generating section which supplies a luminance signal of an achromatic color to the liquid crystal display unit by computing display data of a plurality of colors corresponding to one pixel which are supplied from an image source. According to this arrangement, a monochrome image can be displayed. In addition, in this liquid crystal display device, it is preferable that the display driver further has a monochrome display switching section which supplies a luminance signal generated by the monochrome data generating section to the liquid crystal display unit in accordance with selection of monochrome display. The monochrome data generating section preferably has a data computing section which concurrently receives display data of colors corresponding to one pixel which are read out from the memory circuit, multiplies the display data corresponding to the respective colors by predetermined coefficients, and adds the display data, thereby generating luminance data for monochrome display. The memory write section concurrently and continuously writes display data of a plurality of colors in corresponding memories of the plurality of memories for the respective color components over a plurality of frames. The display data read section concurrently reads out display data, of display data corresponding to a plurality of frames stored in the memories corresponding to the respective colors, which correspond to at least a frame immediately preceding a frame for which the display data are written from the respective memories in accordance with selection of monochrome display, and supplies the display data to the data computing section. According to this arrangement, both a color image and a monochrome image can be displayed by the simplified circuit arrangement.

Preferably, this liquid crystal display device capable of displaying a monochrome image further comprises a frame frequency reducing circuit which reduces a frame frequency for driving the liquid crystal display unit. According to this arrangement, by reducing the frame frequency for displaying a monochrome image, the power consumption for display driving operation of the liquid crystal display device can be greatly reduced, and the power supply can be effectively used. In addition, the device preferably comprises a shutoff circuit which shuts off a backlight. According to this arrangement, since a monochrome image can be displayed by using this device as a reflective type liquid crystal display device while the illumination device is shut off, there is no need to consume power to turn on the illumination device. This makes it possible to effectively use the power supply.

In the liquid crystal display device of the present invention, the illumination device preferably comprises a light source which emits light beams of primary colors of red, green, and blue, the display data supplied from an image source is constituted by display data of the respective color components of red, green, and blue, the plurality of memories comprise three memories which respectively store display data of the respective color components of red, green, and blue, two frames at a time, the memory write section concurrently and continuously writes display data of a plurality of colors for the respective color components over a plurality of frames in the corresponding memories of the plurality of memories, and the display data read section sequentially reads out display data, of display data corresponding to a plurality of frames stored in the memories corresponding to the respective colors, which correspond to at least a frame immediately preceding a frame for which the display data are written from the memories corresponding to the respective colors. Preferably, the memory write section of this liquid crystal display device concurrently and continuously writes display data of three colors for the respective color components over the two frames in the respective memories corresponding to the respective color components, and the display data read section sequentially reads out display data, of display data corresponding to two frames stored in the memories corresponding to the respective colors, which correspond to a frame immediately preceding a frame for which the display data are written from the memories corresponding to the respective colors, as display data for the respective fields, in a predetermined order of the memories of the respective colors. This makes it possible to simplify the structure of the driving circuit.

According to another aspect of the present invention, there is provided a liquid crystal display device comprising display means having a plurality of pixels arranged in the form of a matrix, and displaying an image by using the plurality of pixels, illumination means placed behind the display means and sequentially emitting light beams of a plurality of colors to the display means in predetermined cycles, and driving means formed into an integrated circuit and supplying display data corresponding to one of the plurality of colors to the display means for each of a plurality of fields obtained by dividing one frame for displaying one color image by the number of colors of light beams emitted from the illumination means to cause the illumination means to emit light beams of corresponding colors in accordance with display of the display data, thereby displaying one color image upon synthesis of display of a plurality of colors for the respective fields, wherein the driving means has a plurality of storage means for storing display data of a plurality of colors for the respective color components, memory write means for causing the plurality of storage means to store display data of a plurality of colors supplied in parallel from an image source for the respective color components, and display data read means for serially reading out display data of a plurality of colors stored in the plurality of storage means for each color and supplying the display data to the display means, the plurality of storage means, the memory write means, and the display data read means being formed within the same integrated circuit. According to this arrangement, the arrangement between the image source and the driver module can be greatly simplified. In addition, the above arrangement can contribute to a reduction in EMI due to the wiring pattern and a reduction in signal loss at the time of image data transfer. In this liquid crystal display device, each of the plurality of storage means may be formed from only a FIFO (First In First Out) memory. In addition, each of the plurality of storage means preferably has a storage capacity of not less than 2×n×m bits, where n is the number of bits representing one image data by digital data and m is the number of scanning lines of the display means. Furthermore, it is preferable that the memory write means concurrently and continuously writes display data of three colors for the respective color components over the two frames in the respective storage means corresponding to the respective color components, and the display data read means sequentially reads out display data, of display data corresponding to two frames stored in the storage means corresponding to the respective colors, which correspond to a frame immediately preceding a frame for which the display data are written from the storage means corresponding to the respective colors, as display data for the respective fields, in a predetermined order of the storage means of the respective colors.

According to still another aspect of the invention, there is provided a driving method for a liquid crystal display device, comprising a step of causing a plurality of FIFO (First In First Out) memories, each having a storage capacity of not less than 2×n×m bits, where n is the number of bits representing one image data by digital data and m is the number of scanning lines of the liquid crystal display unit, to store display data of a plurality of colors, for the respective color components, which are supplied in parallel from an image source, a display data read/supply step of serially reading out display data of a plurality of colors stored in the plurality of memories for each of a plurality of fields obtained by dividing one frame for displaying one color image by the number of colors of the display data in a predetermined order of colors, and supplying the data to the liquid crystal display unit, and an illumination device lighting step of causing an illumination device to generate light beams of colors corresponding to display for each field based on the display data and emit the light beams to the liquid crystal display unit, wherein one color image is displayed by synthesizing display of a plurality of colors for each of a plurality of fields on the basis of display data corresponding to the plurality of colors.

Preferably, the step of causing the plurality of FIFO memories to store includes a write step of concurrently and continuously writing display data of primary colors of red, green, and blue, supplied from an image source, for the respective color components over two frames, in memories corresponding to the respective color components. The display data read/supply step may include a step of sequentially reading out display data, of display data corresponding to two frames stored in the memories corresponding to the respective colors, which correspond to a frame immediately preceding a frame for which the display data are written from the memories corresponding to the respective colors, as display data for the respective fields, in a predetermined order of the memories of the respective colors, and supplying the display data to the liquid crystal display unit.

According to this driving method, parallel color image data from an image source can be directly received, and the received data can be converted into serial data upon being stored in the memories arranged in the module, thereby driving the display device. This makes it possible to greatly simplify the arrangement between the image source and the driver module. In addition, this method can contribute to a reduction in EMI due to the wiring pattern and a reduction in signal loss at the time of image data transfer.

### BRIEF DESCRIPTION OF THE SEVERAL VIEWS OF THE DRAWING

FIG. 1 is a perspective view showing the overall arrangement of a liquid crystal display device according to the present invention;

FIG. 2 is a block diagram illustrating an image data transfer step in a field sequential scheme according to an embodiment of the present invention;

FIG. 3 is a block diagram showing the schematic arrangement of a driving circuit according to the embodiment of the present invention;

FIG. 4 is a block diagram showing the circuit arrangement of part of the driving circuit in FIG. 3;

FIG. 5 is a block diagram showing the detailed circuit arrangement of a data computing section in FIG. 4;

FIG. 6 is a view illustrating write/read operation in memories in the color display mode according to the embodiment of the present invention;

FIG. 7 is a view illustrating write/read operation in the memories in the monochrome display mode according to the embodiment of the present invention; and

FIG. 8 is a block diagram illustrating a conventional image data transfer step in the field sequential scheme.

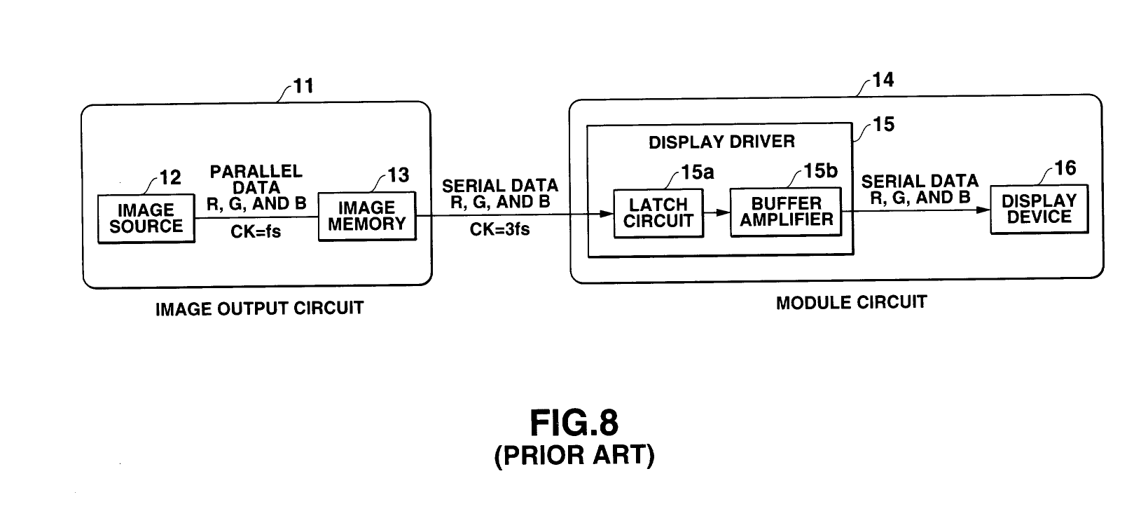

### DETAILED DESCRIPTION OF THE INVENTION

Liquid crystal display devices will be described below as embodiments of the present invention with reference to the accompanying drawings.

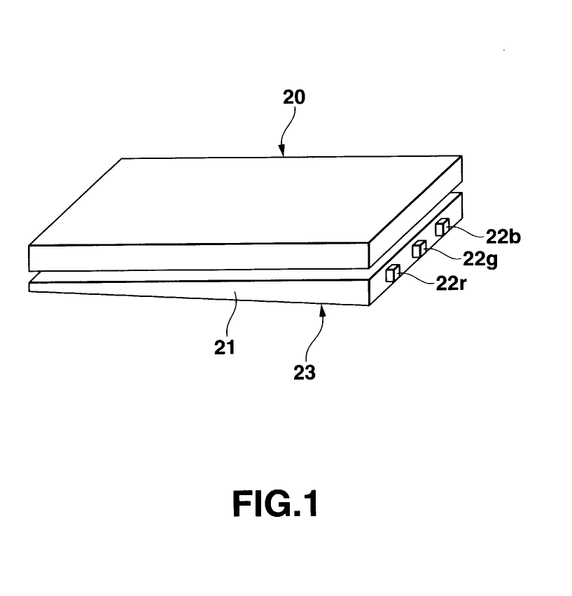

The present invention relates to a field sequential liquid crystal display device. As shown in FIG. 1, the display device includes an active matrix type homogeneous alignment liquid crystal display unit 20 which has a plurality of pixels arranged in the form of a matrix and controls the optical transmission of each pixel in accordance with the voltage applied to the electrode of each pixel, an optical waveguide 21 placed on the opposite side to the observation side of the liquid crystal display unit 20, and an illumination device 23 constructed by a backlight having light sources 22r, 22g, and 22b which are arranged on one end of the optical waveguide 21 and emit light beams of red R, green G, and blue B. The illumination device illuminates the liquid crystal display unit 20 by uniformly guiding light beams from the light sources 22r, 22g, and 22b of the respective colors to the entire surface of the liquid crystal display unit 20.

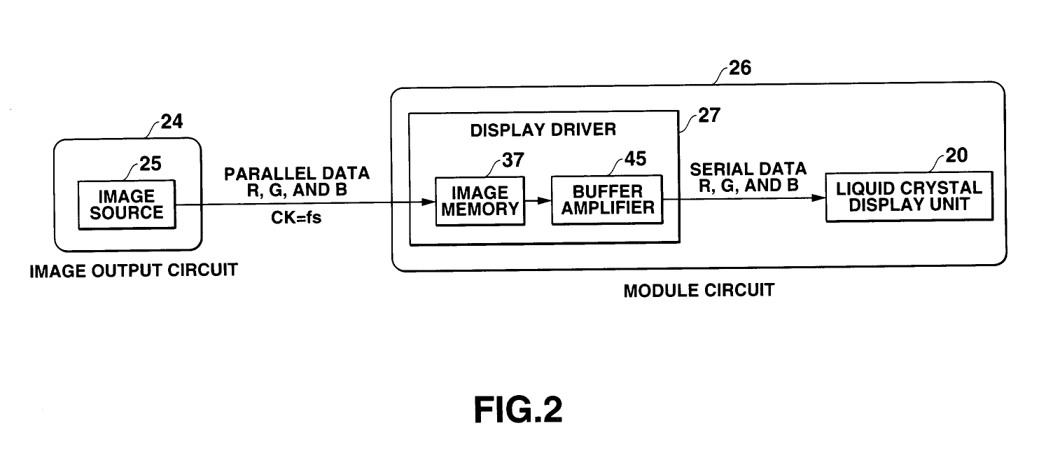

FIG. 2 illustrates a step of transferring image data by a field sequential scheme associated with the liquid crystal display device of the present invention. As shown in FIG. 2, primary-color image data RGB supplied in parallel from an image source 25 of an image output circuit 24 are directly sent to a display driver 27 of a module circuit 26.

The display driver 27 is mainly constituted by an image memory 37 and buffer amplifier 45. The parallel image data RGB from the image output circuit 24 are stored in the image memory 37. These data are then sequentially read out by the buffer amplifier 45 and supplied as the serial image data RGB to the liquid crystal display unit 20, thereby displaying an image corresponding to the image data.

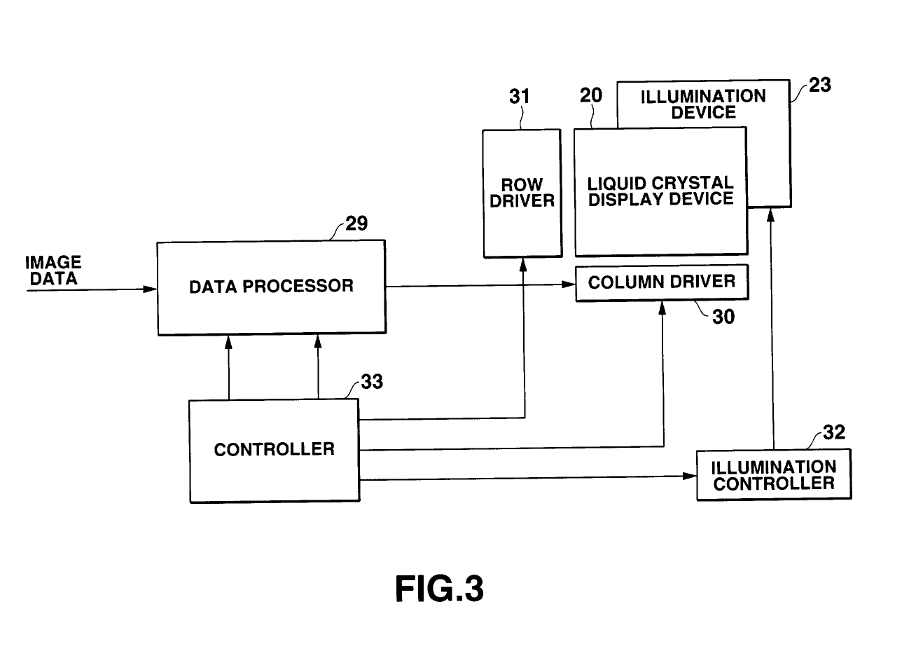

The above field sequential liquid crystal display device is driven by the display driver, as shown in FIG. 3. This display driver 27 is comprised of a data processor 29 to which image data are externally supplied, a column driver 30 which supplies data signals corresponding to the respective image data to the respective data lines of the liquid crystal display unit 20 on the basis of the image data supplied from the data processor 29, a row driver 31 which supplies gate signals for sequentially scanning the respective gate lines to the gate lines of the liquid crystal display unit 20, an illumination controller 32 which drives the illumination device 23, and a controller 33 which controls the operation of the data processor 29, row driver 31, column driver 30, and illumination controller 32.

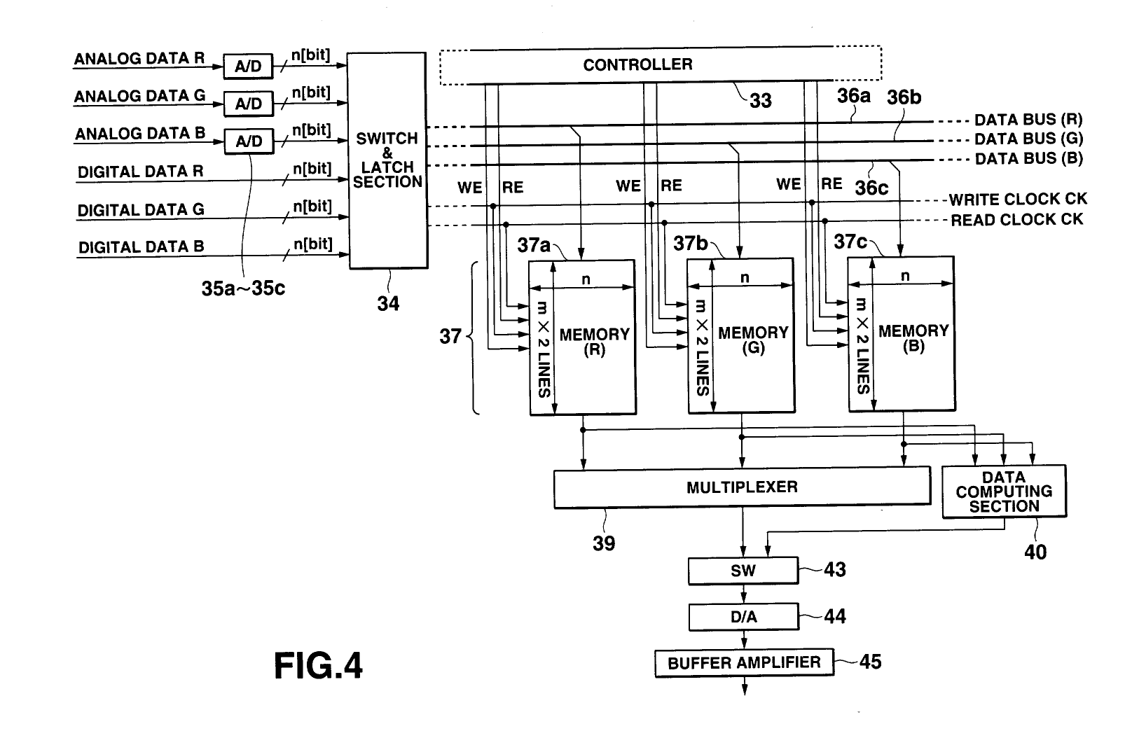

FIG. 4 shows the schematic arrangement of the data processor 29 which corresponds to one output channel of data lines. In this case, both analog image data RGB and digital image data RGB can be input to the data processor 29.

Referring to FIG. 4, n bits of each of the digital image data RGB are directly input to a switch (SW) & latch section 34, while the analog image data RGB are input to the switch & latch section 34 after they are digitized into n-bit data of the respective colors by A/D converters 35a to 35c.

The switch & latch section 34 selectively latches the image data RGB digitized by the A/D converters 35a to 35c or the directly input digital image data RGB and outputs the respective color components to corresponding data buses 36a to 36c.

Memories 37a to 37c constituting the image memory 37 are connected to the data buses 36a to 36c. Write enable signals WE and read enable signals RE are input from the controller 33 to the memories 37a to 37c. In addition, write clocks CK and read clocks CK are supplied to the memories 37a to 37c.

Assume that there are m scanning lines for image data to be processed in this embodiment. In this case, each of the memories 37a to 37c is formed from a FIFO (First In First Out) memory which has a capacity of n bits×m lines×2 or more and can store image data corresponding to two frames or more. Of the image data input through the data buses 36a to 36c, R, G, and B data which form the same pixel are written at the same timing, sequentially transferred within the memories 37a to 37c, and read out.

When, therefore, image data on the same data line which correspond to the scanning lines of the display module of the liquid crystal display unit 20 are stored in the memories 37a to 37c for each pixel, image data corresponding to one frame are stored in the memories 37a to 37c as a whole.

The R, G, and B data of the image data read out from the memories 37a to 37c are sent to a multiplexer 39 and data computing section 40.

The multiplexer 39 is used in the color display mode (to be described later). The multiplexer 39 sequentially selects outputs from the memories 37a to 37c and outputs them to a mode switch (SW) 43.

The data computing section 40 as part of a monochrome data generator is used in the monochrome display mode (to be described later). The data computing section 40 calculates luminance data for monochrome display from the RGB data output from the memories 37a to 37c and outputs the calculated data to the mode switch 43.

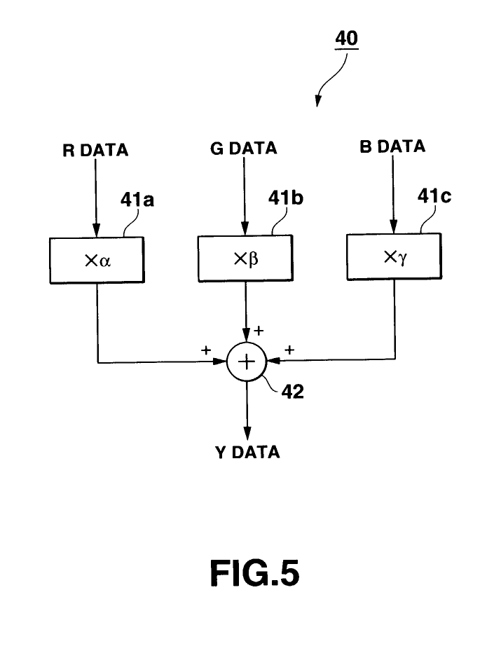

FIG. 5 shows the detailed circuit configuration of the data computing section 40. Referring to FIG. 5, multipliers (Xα, Xβ, Xγ) 41a to 41c multiply the R, G, and B data read out from the memories 37a to 37c by predetermined multiplier factors α, β, and γ (0≦α, β, γ≦1), and output the products.

Assume that the respective multiplier factors in the multipliers 41a to 41c can be set to arbitrary values.

When an adder 42 adds the products output from the multipliers 41a to 41c, luminance (Y) data for monochrome display is calculated from the RGB data constituting a color image.

The mode switch 43 selects an output from the multiplexer 39 in the color display mode, selects an output from the data computing section 40 in the monochrome display mode, and outputs the selected output to a D/A converter (D/A) 44.

The D/A converter 44 converts the image data sent from the mode switch 43 into an analog signal and outputs it. The output analog image signal is sequentially amplified by a predetermined amplification factor, using a buffer amplifier 45 and then supplied to the data line of the liquid crystal display unit 20 through the column driver 30.

The operation of the above embodiment will be described next.

Operation in the color display mode will be described first.

Assume that one-frame image data is displayed in 1/60 [sec]. In accordance with this speed, image data are sequentially transferred from the image source 25 of the image output circuit 24, and R, G, and B image data are supplied to the display unit for each field obtained by dividing one frame by three.

R, G, and B image data corresponding to one frame are therefore sequentially stored in the memories 37a to 37c in 1/60 [sec], and one-field image data for each color component is sequentially read out and sent to the multiplexer 39 at a speed three times higher than that in storing operation, i.e., in 1/180 [sec].

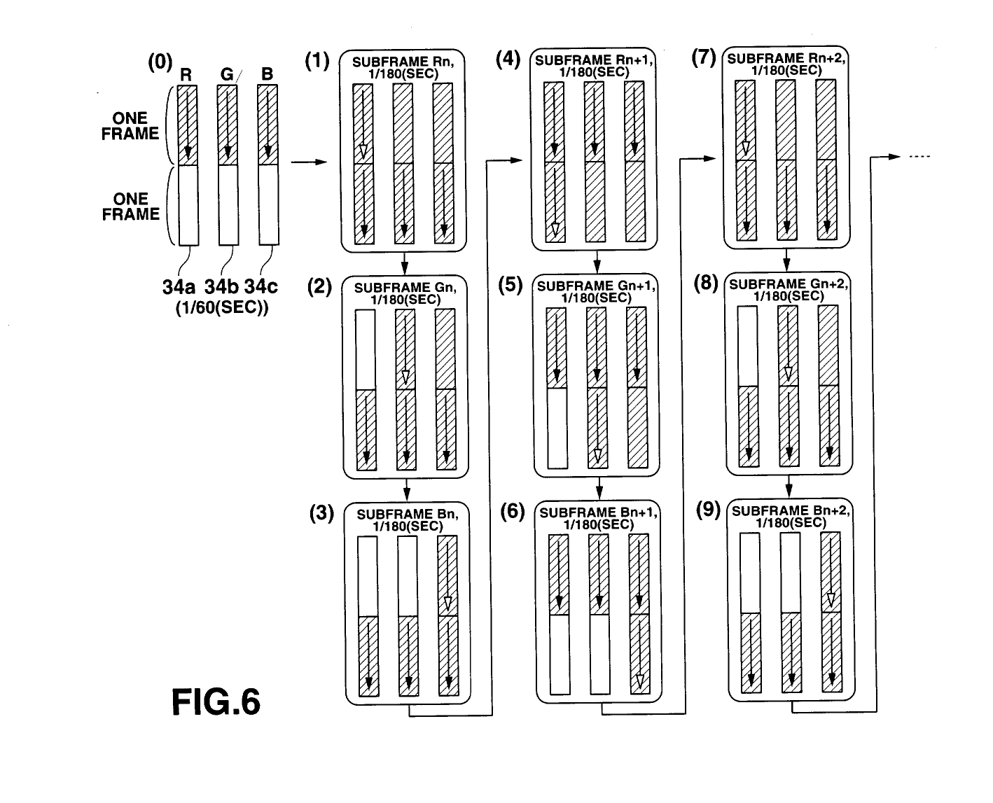

FIG. 6 shows the transitions of write/read states in the memories 37a to 37c in the color display mode. Referring to FIG. 6, the hatching sections indicate states where image data are written in the memories 37a to 37c each having a capacity of two frames, each arrow with a solid arrowhead indicates image data write operation, and each arrow with a hollow arrowhead indicates image data read operation.

First of all, as indicated by “(0)” in FIG. 6, one-frame image data R, G, and B are simultaneously written in the memories 37a to 37c in 1/60 [sec], in which no image data are currently written. Thereafter, as indicated by “(1)” to “(3)” in FIG. 6, image data R, G, and B corresponding to the second frame are continuously written in the memories 37a to 37c.

At the same time when the respective image data R, G, and B corresponding to the first frame are completely written, the R data corresponding to the first field of the first frame is read out from the memory (R) and output to the multiplexer 39 in an interval of 1/180 [sec] corresponding to one field, as indicated by “(1)” in FIG. 6. Subsequently, as indicated by “(2)” in FIG. 6, the G data corresponding to one frame is read out in 1/180 [sec] and output as G data corresponding to the second field of the first frame to the node 36. Thereafter, as indicated by “(3)” in FIG. 6, the B data corresponding to one frame is read out in 1/180 [sec] and output as B data corresponding to the third field of the first frame to the multiplexer 39.

As indicated by “(4)” to “(6)” in FIG. 6, writing of image data R, G, and B corresponding to the third frame is then started from the heads of the respective memories 37a to 37c. After this write is completed in 1/60 [sec], image data R, G, and B corresponding to the fourth frame are continuously written in the respective memories in 1/60 [sec].

After image data R, G, and B corresponding to the first frame are completely read out, the image data R corresponding to the second frame is read out from the memory (R) 37a from the beginning in 1/180 [sec] and output as R data corresponding to the second field to the multiplexer 39, as indicated by “(4)” in FIG. 6. Subsequently, as indicated by “(5)” in FIG. 6, the image data G corresponding to the second frame begins to be read out from the memory (G) 37b from the beginning, and the G data corresponding to the second field of the second frame is read out in 1/180 [sec] and output to the multiplexer 39.

As indicated by “(6)” in FIG. 6, the image data B corresponding to the second frame begins to be read out from the memory (B) 37c from the beginning, and the B data corresponding to the third field of the second frame is read out in 1/180 [sec] and output to the multiplexer 39.

The above operation described with reference to “(1)” to “(6)” in FIG. 6 is repeatedly executed at “(7)” in FIG. 6 and thereafter. In accordance with this operation, the multiplexer 39 sequentially selects and outputs image data R, G, and B, which are read out as the respective color components corresponding to one frame from the memories 37a to 37c in cycles of one field corresponding to 1/180 [sec], in three fields. These image data are converted into analog data by the D/A converter 44 through the mode switch 43. The analog data are then supplied as serial image data to the column driver 30, from which display data are supplied to the respective data lines of the liquid crystal display unit 20, thus performing displaying operation.

The illumination controller 32 sequentially turns on the light sources of the illumination device 23 which correspond to the respective color components R, G, and B in synchronism with this operation, thereby displaying one-frame image data temporally divided into the respective color components. This allows the user to visually recognize the resultant image as a color image synthesized by the persistence of human vision.

As described above, the memories 37a to 37c constituting the image memory 37 are provided in the display driver 27 of the module circuit 26 having the display unit 20 to directly receive parallel R, G, and B data from the image source 25 and sequentially write the data in the memories 37a to 37c in the order of frames. The written R, G, and B data are sequentially read out in cycles of one field corresponding to ⅓ of one frame and supplied to the multiplexer 39. These data are then converted into serial data by the multiplexer 39, thereby driving the liquid crystal display unit 20 through the column driver 30 to display an image.

In other words, the memory write section including control signals from the controller 33 concurrently and continuously writes three-color display data in the memories corresponding to the respective color components over two frames for the respective color components, whereas the memory read section including control signals from the controller 33 and the mode switch 43 sequentially reads out display data, of the two-frame display data stored in the memories corresponding to the respective colors, which correspond to a frame immediately preceding a frame for which the display data are written, from the memories corresponding to the respective colors as one-field display data in the predetermined order of the memories for the respective colors.

The arrangement between the module circuit 26 and the image output circuit 24 having the image source 25 can therefore be greatly simplified. In addition, the above arrangement can contribute to a reduction in EMI due to a wiring pattern and a reduction in signal loss at the time of image data transfer.

Operation in the monochrome display mode will be described next.

Assume that one-frame image data are displayed in 1/60 [sec], and image data are sequentially transferred from the image source 25 of the image output circuit 24 in accordance with this speed.

Therefore, one-frame image data are sequentially stored in the memories 37a to 37c in 1/60 [sec], whereas one-frame image data are read out for each color component in 1/60 [sec] as in read operation, and are sent to the data computing section 40.

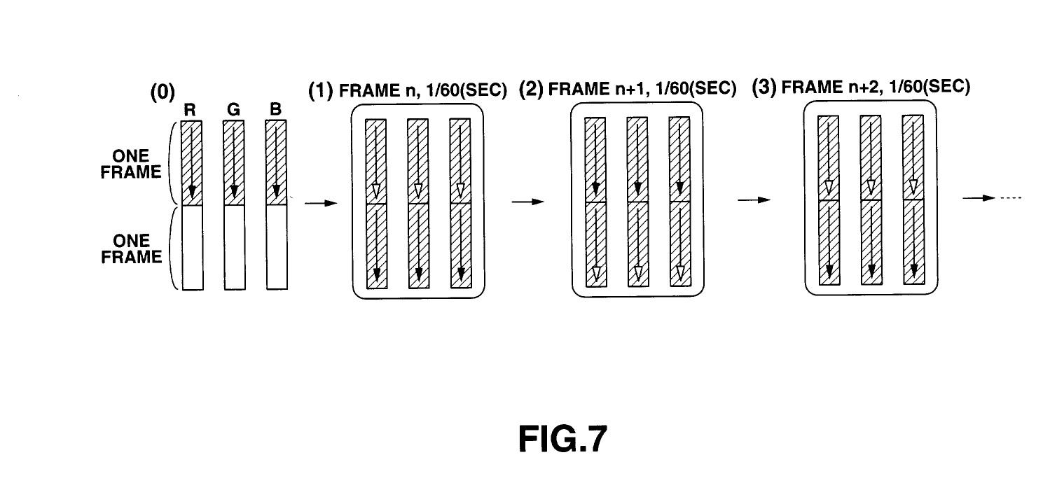

FIG. 7 shows the transitions of write/read states in the memories 37a to 37c in the monochrome display mode. Referring to FIG. 7, the hatching sections indicate states where image data are written in the memories 37a to 37c each having a capacity of two frames, each arrow with a solid arrowhead indicates image data write operation, and each arrow with a hollow arrowhead indicates image data read operation.

First of all, as indicated by “(0)” in FIG. 7, one-frame image data R, G, and B are simultaneously written in the memories 37a to 37c in 1/60 [sec], in which no image data are currently written. Subsequently, image data R, G, and B corresponding to the second frame are continuously written in the memories 37a to 37c, as indicated by “(1)” in FIG. 7.

As indicated by “(1)” in FIG. 7, previously written one-frame image data R, G, and B are simultaneously read out from the heads of the memories 37a to 37c for the respective R, G, and B data color components and output to the data computing section 40.

As indicated by “(2)” in FIG. 7, one-frame R, G, and B image data are simultaneously read out from the memories 37a to 37c, starting from the head of the second frame, in 1/60 [sec], and output to the data computing section 40.

The operation described with reference to “(1)” and “(2)” in FIG. 7 is repeatedly executed at “(3)” in FIG. 7 and thereafter. In the data computing section 40 shown in FIG. 5, the multipliers 41a to 41c multiply the one-frame image data simultaneously read out from the memories 37a to 37c in 1/60 [sec] by the predetermined multiplier factors α, β, and γ and output the products.

In this case, according to the NTSC system which is the standard television system in Japan, luminance (Y) data and R, G, and B color data are defined as follows.

Y=0.299×R+0.587×G+0.144×B (1)

Assuming that the respective multiplier factors in the data computing section 40 are set in accordance with this expression (1),

α=0.299, β=0.587, and γ=0.144

After the respective color component data are multiplied by these multiplier factors in this manner, the adder 42 addes the products together. The resultant sum becomes luminance (Y) data. The luminance data calculated by the data computing section 40 is converted into analog data by the D/A converter 44 through the mode switch 43. The buffer amplifier 45 then supplies this data as serial image data to the column driver 30 to drive the display unit 20.

The illumination device 23 simultaneously turns on the light sources of the backlight which correspond to the respective color components R, G, and B in synchronism with this operation to generate and emit white light, thereby displaying one-frame monochrome image data.

In other words, the memory write section including control signals from the controller 33 concurrently and continuously writes display data of a plurality of colors in the memories corresponding to the respective color components over a plurality of frames for the respective color components, whereas the memory read section including control signals from the controller 33 and the mode switch 43 concurrently reads out display data, of the display data corresponding to a plurality of frames and stored in the memories corresponding to the respective colors, which correspond to a frame immediately preceding a frame for which the display data are written, from the respective memories in accordance with the selection of monochrome display, and supplies the data to the data computing section 40.

As described above, a monochrome image can be easily displayed by adding circuits with simple arrangements such as the data computing section 40 and mode switch 43 and controlling them.

In the monochrome display mode, unlike in the color display mode, the write and read speeds with respect to the memories 37a to 37c can be set to be the same. With regard to the read speed, in particular, since no subframe driving is done, the frame frequency for scanning all the scanning lines of the display unit 20 can be reduced to ⅓ in accordance with three color components R, G, and B. For this reason, when display is to be performed in the monochrome display mode, since the controller for this display driver has a frame frequency reducing circuit that operates together with the transfer of image data for monochrome display, monochrome display can be done at a frame frequency ⅓ that for color display. This makes it possible to greatly reduce the power consumption for display driving of the display unit 20. Hence, even a power supply with limited capacity such as a battery can be effectively used.

According to the above description, in the monochrome display mode, the light sources of the backlight corresponding to the respective color components R, G, and B are simultaneously turned on. If, however, the display unit 20 has a reflector so that it can also be used as a reflective type liquid crystal display panel, it is preferable that the illumination controller for the display driver additionally has a shutoff circuit for the backlights. In this case, when image data for monochrome display is transferred, the shutoff circuit for the backlight may be operated to shut off the backlight.

In this case, since the display unit 20 can be used as a reflective type liquid crystal display panel, the power required to turn on the backlight, which occupies a large proportion of the power consumption, need not be consumed. This makes it possible to use a power supply with limited capacity more effectively.

Note that the present invention is not limited to the above embodiment, and can be variously modified and practiced without departing from the spirit and scope of the invention.

The above embodiment includes inventions of various stages, and various inventions can be extracted by proper combinations of a plurality of disclosed constituent elements. When, for example, at least one of the problems described in “BACKGROUND OF THE INVENTION” can be solved and at least one of the effects described in “BRIEF SUMMARY OF THE INVENTION” can be obtained even if several constituent elements are omitted from the all the constituent elements in each embodiment, the arrangement from which these constituent elements are omitted can be extracted as an invention.

What is claimed is:

1. A liquid crystal display device comprising:
a matrix liquid crystal display unit having a plurality of pixels arranged in the form of a matrix;
an illumination device which is placed behind the display unit and sequentially emits light beams of a plurality of colors to the liquid crystal display unit in predetermined cycles; and
a display driver formed into an integrated circuit which supplies display data corresponding to one of the plurality of colors to the liquid crystal display unit for each of a plurality of fields obtained by dividing one frame for displaying one color image by the number of colors of light beams emitted from the illumination device to cause the illumination device to emit light beams of corresponding colors in accordance with display of the display data, thereby displaying one color image upon synthesis of display of a plurality of colors for the respective fields,
wherein the display driver has a plurality of memories which store display data of a plurality of colors for the respective color components,
a memory write section which causes the plurality of memories to store display data of a plurality of colors supplied in parallel from an image source for the respective color components, and
a display data read circuit which serially reads out display data of a plurality of colors stored in the plurality of memories for each color and supplies the display data to the liquid crystal display device, the memories, the memory write section, and the display data read circuit being formed within the same integrated circuit.

2. A device according to claim 1, wherein each of the plurality of memories has a FIFO (First In First Out) memory.

3. A device according to claim 1, wherein each of the plurality of memories has a storage capacity of not less than 2×n×m bits, where n is the number of bits representing one image data by digital data and m is the number of scanning lines of the liquid crystal display unit.

4. A device according to claim 1, wherein
the illumination device comprises light sources which emit light beams of primary colors of red, green, and blue, and
the plurality of memories have three memories which respectively store display data of the respective color components of red, green, and blue.

5. A device according to claim 1, wherein
the memory write section concurrently and continuously writes display data of a plurality of colors for the respective color components over a plurality of frames in corresponding memories of the plurality of memories, and
the display data read section sequentially reads out display data, of display data corresponding to a plurality of frames stored in the memories corresponding to the respective colors, which correspond to at least a frame immediately preceding a frame for which the display data are written from the memories corresponding to the respective colors.

6. A device according to claim 1, wherein
the illumination device comprises light sources which emit light beams of primary colors of red, green, and blue,
the plurality of memories comprise three FIFO (First In First Out) memories each having a storage capacity of not less than 2×n×m bits where n is the number of bits representing one image data by digital data and m is the number of scanning lines of the liquid crystal display unit,
the memory write section concurrently and continuously writes display data of three colors for the respective color components over the two frames in the respective memories corresponding to the respective color components, and
the display data read section sequentially reads out display data, of display data corresponding to two frames stored in the memories corresponding to the respective colors, which correspond to a frame immediately preceding a frame for which the display data are written from the memories corresponding to the respective colors, as display data for the respective fields, in a predetermined order of the memories of the respective colors.

7. A device according to claim 1, wherein the display driver further has a monochrome data generating section which supplies a luminance signal of an achromatic color to the liquid crystal display unit by computing display data of a plurality of colors corresponding to one pixel which are supplied from an image source.

8. A device according to claim 7, wherein the display driver further has a monochrome display switching section which supplies a luminance signal generated by the monochrome data generating section to the liquid crystal display unit in accordance with selection of monochrome display.

9. A device according to claim 7, wherein the monochrome data generating section has a data computing section which concurrently receives display data of colors corresponding to one pixel which are read out from the memory circuit, multiplies the display data corresponding to the respective colors by predetermined coefficients, and adds the display data, thereby generating luminance data for monochrome display.

10. A device according to claim 9, wherein
the memory write section concurrently and continuously writes display data of a plurality of colors in corresponding memories of the plurality of memories for the respective color components over a plurality of frames, and
the display data read section concurrently reads out display data, of display data corresponding to a plurality of frames stored in the memories corresponding to the respective colors, which correspond to at least a frame immediately preceding a frame for which the display data are written from the respective memories in accordance with selection of monochrome display, and supplies the display data to the data computing section.

11. A device according to claim 7, wherein the display driver further has a frame frequency reducing circuit which reduces a frame frequency for driving the liquid crystal display unit.

12. A device according to claim 7, wherein the display driver further has a shutoff circuit which shuts off a backlight.

13. A device according to claim 1, wherein
the illumination device has light sources which emit light beams of primary colors of red, green, and blue,
the display data supplied from an image source is constituted by display data of the respective color components of red, green, and blue,
the plurality of memories comprise three memories which respectively store display data of the respective color components of red, green, and blue, two frames at a time,
the memory write section concurrently and continuously writes display data of a plurality of colors for the respective color components over a plurality of frames in corresponding memories of the plurality of memories, and
the display data read section sequentially reads out display data, of display data corresponding to a plurality of frames stored in the memories corresponding to the respective colors, which correspond to at least a frame immediately preceding a frame for which the display data are written from the memories corresponding to the respective colors.

14. A device according to claim 13, wherein
the memory write section concurrently and continuously writes display data of three colors for the respective color components over the two frames in the respective memories corresponding to the respective color components, and
the display data read section sequentially reads out display data, of display data corresponding to two frames stored in the memories corresponding to the respective colors, which correspond to a frame immediately preceding a frame for which the display data are written from the memories corresponding to the respective colors, as display data for the respective fields, in a predetermined order of the memories of the respective colors.

15. A liquid crystal display device comprising:
display means having a plurality of pixels arranged in the form of a matrix, and displaying an image by using the plurality of pixels;
illumination means placed behind the display device, and sequentially emitting light beams of a plurality of colors to the display means in predetermined cycles; and
driving means formed into an integrated circuit, for supplying display data corresponding to one of the plurality of colors to the display means for each of a plurality of fields obtained by dividing one frame for displaying one color image by the number of colors of light beams emitted from the illumination means to cause the illumination means to emit light beams of corresponding colors in accordance with display of the display data, thereby displaying one color image upon synthesis of display of a plurality of colors for the respective fields,
wherein the driving means has a plurality of storage means for storing display data of a plurality of colors for the respective color components,
memory write means for causing the plurality of storage means to store display data of a plurality of colors supplied in parallel from an image source for the respective color components, and
display data read means for serially reading out display data of a plurality of colors stored in the plurality of storage means for each color and supplying the display data to the display means, the plurality of storage means, the memory write means, and the display data read means being formed within the same integrated circuit.

16. A device according to claim 15, wherein each of the plurality of storage means is formed from only a FIFO (First In First Out) memory.

17. A device according to claim 16, wherein each of the plurality of storage means has a storage capacity of not less than 2×n×m bits, where n is the number of bits representing one image data by digital data and m is the number of scanning lines of the display means.

18. A device according to claim 17, wherein
the memory write means concurrently and continuously writes display data of three colors for the respective color components over the two frames in the respective storage means corresponding to the respective color components, and
the display data read means sequentially reads out display data, of display data corresponding to two frames stored in the storage means corresponding to the respective colors, which correspond to a frame immediately preceding a frame for which the display data are written from the storage means corresponding to the respective colors, as display data for the respective fields, in a predetermined order of the storage means of the respective colors.

19. A driving method for a liquid crystal display device comprising the steps of:
causing a plurality of FIFO (First In First Out) memories, each having a storage capacity of not less than 2×n×m bits, where n is the number of bits representing one image data by digital data and m is the number of scanning lines of the liquid crystal display unit, to store display data of a plurality of colors, for the respective color components, which are supplied in parallel from an image source;
serially reading out display data of a plurality of colors stored in the plurality of memories for each of a plurality of fields obtained by dividing one frame for displaying one color image by the number of colors of the display data in a predetermined order of colors, and supplying the data to the liquid crystal display unit; and
causing an illumination device to generate light beams of colors corresponding to display for each field based on the display data and emit the light beams to the liquid crystal display unit,
wherein one color image is displayed by synthesizing display of a plurality of colors for each of a plurality of fields on the basis of display data corresponding to the plurality of colors.

20. A method according to claim 19, wherein
the step of causing the plurality of FIFO memories to store includes a write step of concurrently and continuously writing display data of primary colors of red, green, and blue, supplied from an image source, for the respective color components over two frames, in memories corresponding to the respective color components, and
the display data read/supply step includes a step of sequentially reading out display data, of display data corresponding to two frames stored in the memories corresponding to the respective colors, which correspond to a frame immediately preceding a frame for which the display data are written from the memories corresponding to the respective colors, as display data for the respective fields, in a predetermined order of the memories of the respective colors, and supplying the display data to the liquid crystal display unit.
